(19) United States
(12) Patent Application Publication
(10) Pub. No.: US 2008/0123976 A1
(43) Pub. Date: May 29, 2008

(54) Remote Picture Editing

(75) Inventors: Kevin Coombs, London (GB); Vasko Tomanov, Little Marlow (GB); Jason Whetton, London (GB)

Correspondence Address: BANNER & WITCOFF, LTD., 1100 13th STREET, N.W., SUITE 1200, WASHINGTON, DC, 20005-4051, US

(73) Assignee: REUTERS LIMITED, London (DE)

(21) Appl. No.: 11/534,306

(22) Filed: Sep. 22, 2006

(51) Int. Cl. G06K 9/36

(52) U.S. Cl. 382/238

(57) ABSTRACT

A system and method for remote picture editing is provided. High-resolution digital image files containing metadata are uploaded onto a hub from computers local to one or more photographers at an event. Lower-resolution copies of the digital images are made and are sent over the Internet to a web server. The web server notifies an editor that the lower-resolution images are available. The editor views the lower-resolution copies over the Internet, selects the images to be used, and using image-processing software, sets editing instructions to be applied to the image. Once the selected image is edited in accordance with the editor's instructions, the edited image is sent to a processor for final editing and application of additional metadata. The processor sends the finalized image to a reviewer for a final check before the image is sent to news and media outlets for publication.

### FIELD

Aspects of the present invention relate generally to a system and method for editing digital photographs or other digital files taken at events and processing them for distribution to media outlets. More particularly, aspects relate to a system and method that permits an editor anywhere in the world to view, select, and edit those files while minimizing the bandwidth needed to do so.

### BACKGROUND

In today's news media, the use of digital technology has transformed the way in which photographers and other reporters work and the way in which the public gets its news. News is increasingly multimedia, with an emphasis on visual aspects such as photographs or videos or aural aspects such as audio recordings. The embodiment of these video or audio recordings in digital files has made their use by news and media outlets much easier.

Photographers and reporters covering an event may take numerous digital photographs for use by news outlets. In addition, it is not uncommon to have many reporters or photographers at an event, particularly a large scale event such as the World Cup soccer match, the Olympics, or the Oscars. These photographers and reporters create a very large number of photographs, which must be viewed, selected, and edited by the news agencies' editorial staff before they are released for use by news and media outlets.

Thus, there is a need for a way for a news agency's editorial staff to access a photographer's digital photographs for review and editing so that the photograph may be distributed to news and media outlets.

One way in which such access has been accomplished previously is for the editor to be on-site at the event with the photographer. In such a system, the photographer transfers her photographs to a computer such as a laptop or PC, which is directly connected, either by a wired or wireless link, to an editor's computer. One or more photographer can be connected to a single on-site editor's computer. The editor then accesses the photographs stored in the photographer's computer, either by transferring them to the editor's computer or by accessing them directly where they are stored, views the photographs, selects one or more desired photographs for use, crops the selected photographs, and transfers the cropped photographs to a computer associated with a processor for further editing such as image correction/enhancement and application of appropriate metadata or captioning. The processor's computer then forwards the edited photographs to a computer associated with a reviewer who makes a final review of the photographs and sends them to news and media outlets for publication.

A disadvantage of this system is that the editor must be on-site at the event, and thus the photographer is limited to working only with the editor who is present and the editor is limited to working on only the photographs for that particular event. In addition, the cost of having an on-site editor may be high, including the cost of travel, accommodations, limited number of individuals representing a company being permitted at the event, etc. as well as the cost of providing the necessary wired or wireless infrastructure between the photographers and the editor's computer.

One system that has been developed to address this shortcoming is the SHOOTLIVE system developed by the PA Group in England. In the SHOOTLIVE system, a photographer transfers her photographs onto a computer running application software. The software creates a lower-resolution preview copy of each photograph and transmits that copy to a remote SHOOTLIVE server. The editor then connects to the SHOOTLIVE server to view the photographs and select desired ones which are then edited and enhanced using image manipulation software. The final image files are then combined with a live data feed and editorial text to create an XML feed that is sent to digital outlets such as a mobile phone or Internet web site. The SHOOTLIVE system, however, supports only a single work flow of photographer, editor, and server, and is not easily scalable for multiple photographers or multiple locations, and thus cannot easily deliver a solution for large events.

In addition, Internet-based applications such as the Apple IPHOTO system or the Kodak EASYSHARE system allow a photographer to upload her photographs to a web server where they can be edited and enhanced for viewing by the photographer's family and friends over the Internet. These applications, however, permit a user only to view the photographs or edit a copy of the photograph residing locally on the user's own computer; they do not permit editing of a photograph residing on a central server. In addition, these solutions are designed to support home users and do not have the workflow or scalability to support large-scale events involving large numbers of high-resolution photographs, multiple photographers, or multiple locations.

### SUMMARY

This summary is provided to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects of the present invention relate to the need for a system and method for editing photographs or other recordations of events that occur world-wide so that they may be efficiently disseminated to news and media outlets. Systems and methods are provided that allows photographers at an event to upload photographs in a first resolution to a hub that creates lower resolution copies of those photographs and allows a remote editor to view those lower-resolution copies, select desired photographs, and provide editing instructions, which are then applied to the high-resolution photographs stored at the hub. According to additional aspects, the edited first resolution images are then sent to a news processor for final editing and processing and are finally distributed to news and media outlets for dissemination to the public.

### BRIEF DESCRIPTION OF THE DRAWINGS

A more complete understanding of the present invention and the potential advantages thereof may be acquired by referring to the following description of illustrative embodiments and accompanying drawings.

FIG. 1 is a flow chart illustrating stages of a system and method for remote picture editing according to one or more aspects described herein.

FIG. 2 is a flow chart providing an overview of steps of a method for remote picture editing according to one or more aspects described herein.

FIG. 3 is a block diagram illustrating a data flow in a method for remote picture editing according to one or more aspects described herein.

FIG. 4 is a block diagram further illustrating a data flow and components that can be used in a system and method for remote picture editing according to one or more aspects described herein.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure. In particular, it should be noted that although the aspects herein are described in the context of a editing and processing a digital photograph, they also can be used with only slight modification for any form of recording of an event such as a video or audio file.

It is noted that various connections are set forth between elements in the following description. It is noted that these connections in general and, unless specified otherwise, may be direct or indirect and that this specification is not intended to be limiting in this respect.

The fast pace of news and the news media has made it more important than ever that photographers, editors, and publishers have ready access to information that can be published in various outlets without undue delay. News increasingly relies on multimedia presentations rather than simply text and print, with photographs, video, and audio becoming more and more important to news organizations. The proliferation of alternative news outlets by the Internet, podcast, or wireless web, also has created a need for a wider array of photographic products than ever before. In addition, the globalization of news means that photographers can be at remote locations, far from editorial or other staff. Events can be large-scale, such as the Olympics, the Oscars, or the World Cup, and have many photographers at multiple locations, or can be smaller scale, with only one or two photographers at one location. A system and method according to various aspects as described herein seeks to meet the needs of photographers, editors, and other news staff in handling photographs in a global news market.

The aspects of a system and method as described herein have many advantages over other systems currently in use. Multiple photographers can send images for processing by a single editor, and multiple editors can view, select, and apply multiple edits to the same set of images. More importantly, a system and method such as is described herein enable an editor to view, select, and edit images anywhere in the world, without having to be in the same location as the event or the photographers. It is also possible for multiple editors to view, select, and apply multiple edits to the same set of images as can be appropriate for use in different media applications or different media outlets. One advantageous aspect of at least some of the present embodiments is that they can use lower-resolution images for transport across the Internet, reducing the bandwidth needs of the system and making it much more flexible, especially for use in areas where reliable, high-speed Internet access is not available.

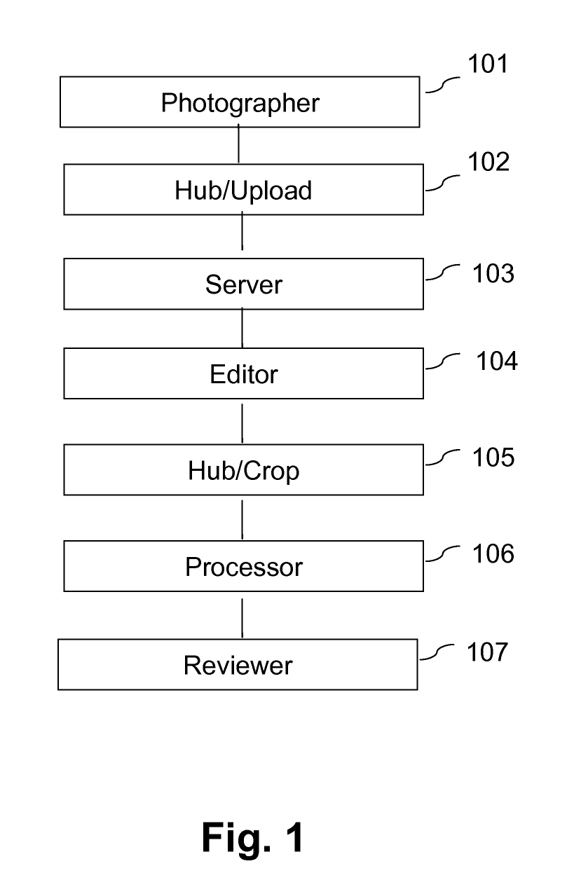

FIG. 1 provides an overview of stages of a method for remote picture editing using aspects described herein. Stage 101 is a photographer stage, in which a photographer transfers high-resolution digital images from digital media to a computer local to the photographer such as the photographer's laptop or PC. Metadata, including an audio clip describing the photograph (if the photographer has supplied one), is added to the picture, either by the photographer application or the hub application; this metadata can be viewed by the editor and can be edited or augmented by the processor. The metadata forms part of the image file and travels with it; when a copy of the digital images is made, the copy contains the metadata from the original, though additional metadata can also be added.

Stage 102 is a hub/upload stage, wherein the high-resolution digital images can be uploaded from the photographer's computer to a computer functioning as a hub and stored in non-volatile memory. The hub can reside in the photographer's computer. This approach may be useful if only one photographer is present at an event or where one photographer is helping to coordinate the uploading the photographs of other photographers. Alternatively, if more than one photographer is present, the hub can be external to any one photographer's computer and can receive uploads from many different photographers at the event. At hub/upload stage 102, hub software can make lower-resolution copies of the original high-resolution images. These lower-resolution copies contain the same image and metadata as the original high-resolution image, but merely at a smaller file size. The hub software can then send the lower-resolution copies to a server functioning as a web server so that access to the lower-resolution images can be made via the Internet.

At server stage 103, the lower-resolution images can be received and stored in non-volatile memory at the server, and the server can notify one or more editors that images are available for review. At editor stage 104, an editor can review the lower-resolution images, select the images to be forwarded to news and media outlets for distribution to the public, and determine a manner in which the selected images are to be used or edited. Editor software records the identification of the selected images and appropriate instructions to be applied to the images, for example, crop instructions or other editing instructions, and forwards the identification and instructions to the hub. At hub/crop stage 105, hub software selects the identified high-resolution images, applies the instructions received from the editor, and saves an edited high-resolution copy of the original image. At processor stage 105, the edited image is then sent via the Internet to a photograph processor, who makes final edits to the edited high-resolution images using standard image processing software; final edits can include additional crops to the image, image correction or enhancement, application of additional metadata or application of a caption. Once the final edits are complete, at reviewer stage 107, the processed image is sent to a reviewer for final review before it is sent to news and media outlets for publication.

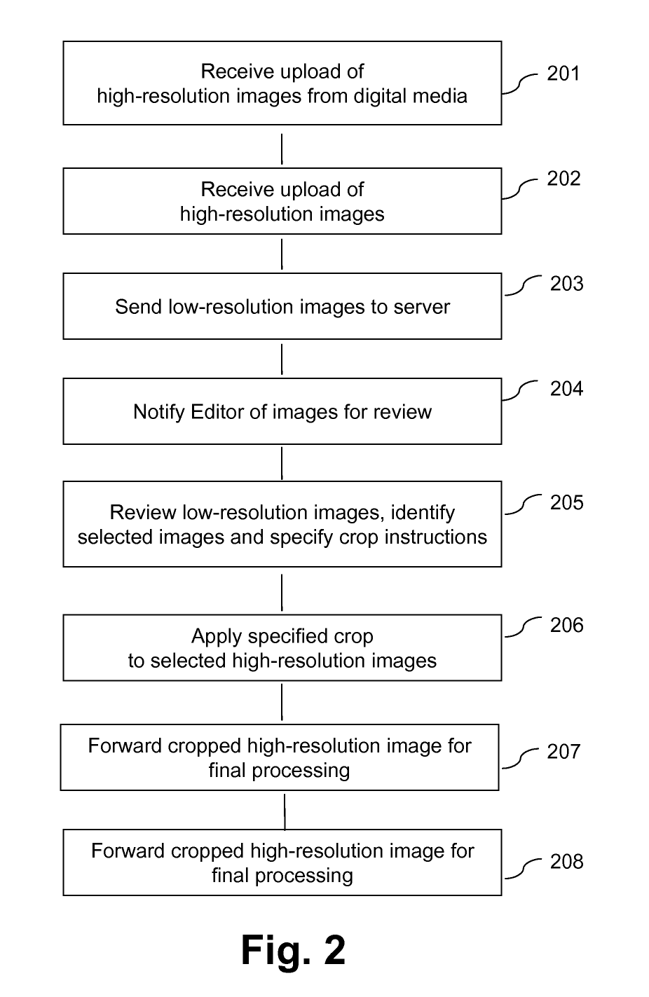

FIG. 2 provides an overview of steps in a method for remote picture editing according to one or more aspects as described herein. At step 201, a photographer's computer receives an upload of high-resolution digital images from digital media associated with a photographer's camera. At step 202, a hub receives an upload of high-resolution images and associated metadata from one or more photographer's computers. At step 203, the hub creates a lower-resolution copy of the high-resolution images and sends over the Internet the lower-resolution copies to a web server. At step 204, the server receives the lower-resolution images and notifies editorial personnel that images are available for review. At step 205, an editor accesses the lower-resolution images stored on the server using a standard web connection, reviews the images, selects and identifies desired images, for example, images to be used for publication, and specifies editing instructions, for example, crop instructions, to be applied to the identified images. At step 206, software running on the hub edits the identified high-resolution images based on instructions specified by the editor in step 204. At step 207, the hub forwards the edited high-resolution images to the processor for final image editing, and at step 208, the processor forwards the finalized image to a reviewer for final review before the finalized image is sent to news and media outlets for publication.

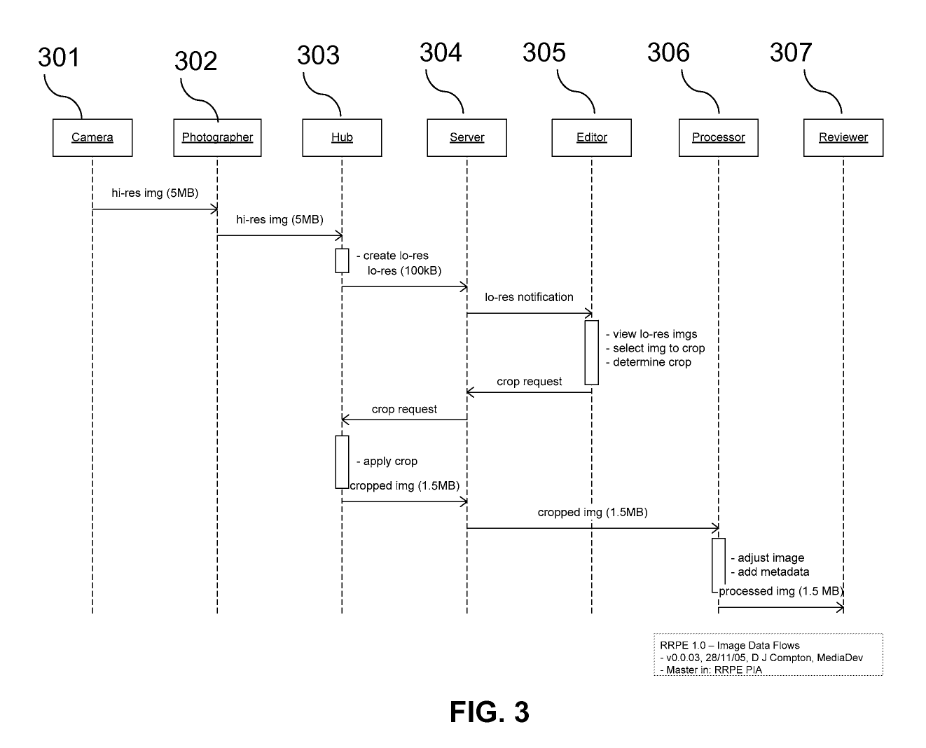

A manner in which data can flow in a method for remote picture editing according to one or more aspects herein is described in more detail with reference to FIG. 3, which illustrates the manner in which data can flow for remote picture editing according to one or more aspects described herein. As shown in FIG. 3, photographic images are recorded on a camera 301, such as a digital camera, by a photographer 302 who is present at an event. The event can be, for example, a small-scale event such as a local government meeting where only one photographer is present, or a large-scale event such as the Olympics, the Oscars, or the World Cup soccer match where multiple photographers are present, taking many photographs at different locations, of different people, or at different times. These photographs can be in the form of high-resolution image files stored on digital media such as a memory stick, SECUREDIGITAL, COMPACTFLASH, SMARTMEDIA, or other type of solid state memory card or dynamic media (DVD, CD, mini-CD, mini-DV, and the like). Because of their high resolution, these digital images can have a very large file size, for example, up to 5 MB or higher.

According to one or more aspects described herein, the high resolution image files are uploaded from the digital media on camera 301 to a photographer's computer 302, for example, a laptop or PC, using any conventional file transfer methods using a wired or wireless connection. The original images can also have associated metadata that forms part of the digital file for the image. This metadata includes an image identifier, for example, an image ID number, and can further include information such as the photographer's name or byline, date and time of the shot, name of the event, or location of the venue, and can be generated automatically by software running on the digital camera or the photographer's computer or be manually applied by the photographer when the image files are loaded onto the computer.

Software residing on the photographer's computer 302 then transfers a copy of the high-resolution image files, including their associated metadata, to a hub 303 where the high-resolution image files are stored in non-volatile memory for use in a method and system for remote picture editing according to various aspects described herein. The hub 303 can reside on a photographer's computer 302 if only one photographer is present at an event, or alternatively can be external to any one photographer's computer and receive files from multiple photographers covering the event. The high-resolution files can be transferred from a photographer's computer 302 to the hub 303 by means of any standard file transfer protocol known in the art, for example, FTP protocol operating on a local or wide area network or a virtual private network (VPN) connection between the photographer's computer 302 and the hub 303.

Software running on hub 303 then creates lower-resolution copies of the high-resolution images that hub 303 has received from a photographer 302. The digital file for a lower-resolution copy of an image can be much smaller than the file for a corresponding high-resolution image. For example, a lower-resolution copy of an image can be approximately 100 kB in size as compared to 5 MB for the high-resolution original image. In accordance with some aspects, the lower-resolution copy typically will contain at least some of the metadata associated with the original high-resolution image, such as the image identifier, the photographer's name or name of the event. The lower-resolution copy can alternatively be given a different image identifier that is linked to the image identifier for the original image so that the lower-resolution copy can easily be associated with the original high-resolution image stored on the hub.

Software running on the hub then transfers the lower-resolution file to a server 304 functioning as a web server for the Internet. Because the file size of the lower-resolution images is small, file transfer can be made by any standard file transfer means available to upload files to the Internet such as TCP/IP, HTTP or other protocol, which greatly increases the flexibility of a method using these aspects. In addition, the small file size reduces the bandwidth needs for the transfer and permits transfer of files from the hub 303 to the server 304 without the necessity for a broadband Internet connection, which can not be available in certain locations.

Once lower-resolution images are uploaded to server 304, software running on server 304 may send a notification to an editor that the lower-resolution images have been uploaded to the server 304 and are available to be viewed. In one embodiment of the aspects herein, an editor can subscribe to one or more sets of photographs available on the server 304 and the notification to the editor is made based on an editor's subscription information. The editor application provides information about the currently available events. Using this information, editors using this can subscribe to receive a feed of images from an event. For example, an editor can subscribe to a set of photographs based on any of the metadata associated with the photograph, such as information relating to the event depicted in the photograph such as the event name (e.g., “Winter Olympics”) or location (e.g., Torino, Italy), the photographer's name or byline (e.g., “John Smith”), or any other metadata that is associated with the photographs on the server. When the photographs and their associated metadata are uploaded onto the server, software running on the server identifies the editors who have subscribed to photographs having one or more of those attributes and sends a notification to the editor 305 that the lower-resolution copies of images stored on the hub are available for viewing. The notification is sent over the Internet, using any standard Internet communication protocol, and can be made via e-mail, instant message, or any other communication medium used over the Internet or other network. In addition, an editor can subscribe for event which is to occur in the future, and when images from that event are uploaded to the server, the editor can start to receive notification regarding the images automatically.

Once an editor 305 receives the notification that the subscribed-to images are available on the web server 304, she logs onto a web server 304 using any standard logon and authentication protocol used for Internet access, such as use of a user name and a password. An advantage of this aspect is that an editor 305 can remotely access images taken by photographer 302 via the Internet or other connected network. Another advantage is that the relatively small file size (100 kB) of the lower-resolution copies permits an editor 305 to view the images using either a broadband or a dial-up connection if, for example, broadband is not available.

Editor 305 then views the subscribed-to images and can select one or more images for publication and further dissemination. Editor 305 identifies a selected image using an image identifier associated with the image, for example, an image number, and software running on the editor's computer stores the image number for the selected images in memory. Editor 305 also makes decisions regarding any edits to be made to a selected image, for example, a crop to be applied to the image, using standard image editing software such as Adobe PHOTOSHOP, and an editor application running on a computer used by editor 305 stores editing instructions in memory. An advantage of this aspect of the described embodiment is that an editor 305 can make more than one set of edits to the same image, for example for use in different publications or different media, using different editing instructions applied to the same image number without making changes to the underlying image itself. According to one or more aspects described herein, software running on a computer used by editor 305 can store a copy of one or more viewed images and editing information, if any, associated with such images, in memory on the editor's computer, while according to other aspects, the software stores only a list of viewed or selected images and editing instructions associated with those images without storing an actual copy of the images. According to still other aspects, software running on a computer used by editor 305 can store a copy of one or more viewed images on the editor's computer and edits can be made directly to that copy of the image rather than to a copy of the image stored at the server or at the hub.

After editor 305 has identified one or more images for publication and has specified any desired editing instructions regarding the identified images, software running on the editor's computer sends a message to server 304 identifying the selected images, for example, by their associated image number or other identifier and can further specify the editing instructions, if any, to be applied to the identified images. In another embodiment, more than one editor can view the same image and make editing decisions for the same image; in this embodiment, each editor's computer sends a separate message to server 304, and each editor's instructions, if any, are stored and processed as a separate editing request.

Software running on server 304 then forwards this editing request to hub 303, where copies of the original high-resolution images are stored. Software running on the hub selects the identified images, applies any specified edits to the selected images, and saves the edited high-resolution image as a separate file such that the original unedited high-resolution image also is maintained. The edited high-resolution images typically can have a smaller file size than the original uncropped high-resolution image, for example about 1.5 MB as opposed to 5 MB for the original file. This reduced file size can permit the transmission of the high-resolution edited files upstream over the Internet.

Software running on hub 303 then forwards the edited high-resolution image to server 304 using any standard Internet file transfer protocol and using a broadband or other Internet connection. Software running on server 304 receives the edited high-resolution image and forwards it to an appropriate processor 306 for additional editing before the image is disseminated for use by news or media outlets.

Processor 306 receives the edited high-resolution images and, using a computer running software such as standard image-processing software (e.g., Adobe PHOTOSHOP), finalizes the image for publication. For example, using software, the processor can add further metadata to the image or can adjust the image to correct color or sharpness, or can make any other adjustments as the software used can allow. Software running on a computer used by processor 306 then forwards the finalized cropped image to reviewer 307 for final review before distribution to news and media outlets for publication.

In another embodiment, editor 305 can download copies of the identified lower-resolution images from server 304 to a computer used by editor 305 and editor 305 can apply the desired edits directly to the lower-resolution images. Such lower-resolution images can then be used for media uses where a higher resolution image is not necessary, for example, for use on Internet web pages, wireless web transmissions, or the like. In such a case, editor 305 can forward the edited lower-resolution images directly to processor 306 without returning any image identification or editing instructions to server 304 or hub 303.

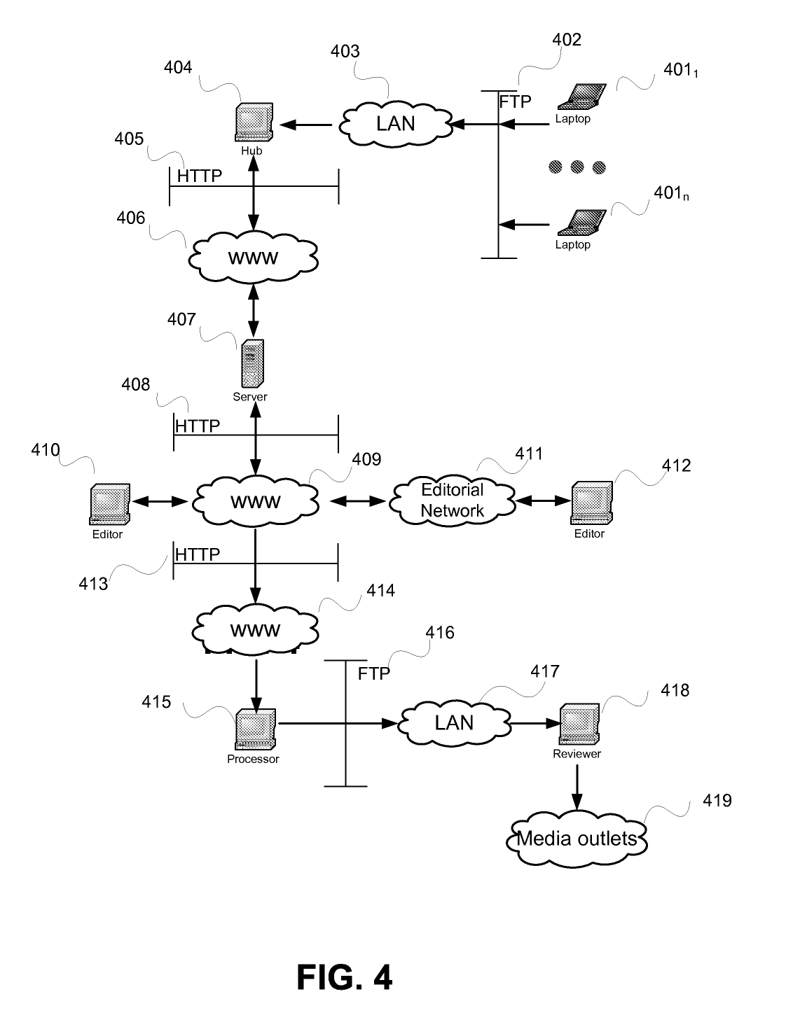

FIG. 4 illustrates components of a system that can be used in a method for remote picture editing according to aspects described herein. As shown in FIG. 4, a system for remote picture editing can include one or more photographer computers 401₁ to 401ₙ, which transfer high-resolution images by means of FTP transfer protocol 402 and LAN 403 to Hub 404. It should be noted that images from the photographer computers to the hub can also be transferred by means of other file transfer protocols, such as HTTP, or by means of any network configuration, such as a WiFi wireless network, Wide Area Network, hard-wired connection, or the like. Hub 404 can be connected to server 407 and can transfer lower-resolution copies of images to server 407 by means of HTTP protocol 406 and internet connection 406 on the World Wide Web. Server 407 can be connected to editor computers 411 and 412 using HTTP protocol 408 over an internet connection on the World Wide Web 409. According to some aspects, editor computer 412 can be connected directly to the server via World Wide Web 409. Alternatively, according to other aspects, editor computer 412 connects to server 407 by means of an intermediate editorial network 422 which in turn can be connected to World Wide Web 409. Components of a system can further include processor computer 416, which can receive edited images from hub 404 via server 407 and over an internet connection 414 over the World Wide Web, and reviewer 418, which can receive processed images from processor computer 415 by means of FTP transfer protocol 416 and local area network 417 before sending the final processed images to media outlets 419.

Although the present invention has been described in terms of preferred and exemplary embodiments thereof, numerous other embodiments, modifications and variations within the scope and spirit of the appended claims will occur to persons of ordinary skill in the art from a review of this disclosure.

We claim:

1. A server comprising:
a memory;
a network interface; and
a processor for performing steps including:
receiving a first recording;
associating first metadata with the first recording, the first metadata comprising at least one of a name, a location, a date, and a time;
converting the first recording to a second recording, the second recording having a resolution different than the first recording;
associating the second recording with the first recording;
forwarding the second recording to a second location;
receiving from the second location first instructions pertaining to the second recording;
applying the first instructions to one of the first recording and the second recording, resulting in a third recording;
forwarding the third recording and the metadata for at least one of applying second instructions or adding second metadata to the third recording.

2. The server according to claim 1, wherein the first instructions comprise editing instructions to be applied to one of the first recording and the second recording, and wherein the third recording is an edited recording.

3. The server according to claim 2, wherein the second instructions comprise further editing instructions to be applied to the third recording.

4. A server comprising:
a memory;
a network interface; and
a processor that performs steps including:
receiving from a first location a notification regarding a recording based on metadata associated with the recording, the metadata comprising at least one of a name, a location, a date, and a time;
selecting the recording; and
forwarding instructions pertaining to the recording to the first location.

5. The server of claim 4, wherein the instructions comprise editing instructions to be applied to the recording.

6. A method for editing a recording of an event, comprising the steps of:
receiving a first recording at a first location;
associating first metadata with the first recording, the first metadata including at least one of a name, a location, a date, and a time;
converting the first recording to a second recording, the second recording having a lower resolution than the first recording;
forwarding the second recording and the metadata to a second location;
receiving from the second location first instructions;
applying the first instructions to one of the first recording and the second recording, resulting in an third recording;
forwarding the third recording and the first metadata for at least one of applying second instructions or adding second metadata to the third recording.

7. The method of claim 6, wherein the first instructions comprise editing instructions to be applied to one of the first recording and the second recording, and wherein the third recording is an edited recording.

8. The method of claim 7, wherein the second instructions comprise further editing instructions to be applied to the third recording.

9. The method of claim 6, wherein the third recording and the first metadata are sent to the second location for at least one of applying second instructions or adding second metadata to the third recording.

10. The method of claim 6, wherein the third recording and the first metadata are sent to a third location for at least one of applying second instructions or adding second metadata to the third recording.

11. A method for editing a recording of an event, comprising the steps of:
receiving a first recording and associated metadata at a first location, the metadata comprising at least one of a name, a location, a date, and a time; and
forwarding first instructions pertaining to the first recording to a second location for application of the first instructions to a second recording associated with the first recording.

12. The method of claim 11, further comprising the step of storing at least one of the first instructions and an identity of the first recording in memory.

13. The method of claim 11, further comprising the steps of receiving a notification regarding the first recording, the notification being based on the metadata.

14. The method of claim 11, wherein the first instructions comprise editing instructions to be applied to the second recording, resulting in a third recording.

15. A method for editing a recording of an event, comprising the steps of:
receiving a first recording and associated first metadata at a first location, the first metadata comprising at least one of a name, a location, a date, and a rime;
applying first instructions to the first recording, resulting in a second recording;
forwarding the second recording to a second location for at least one of application of second instructions and addition of second metadata.

16. The method of claim 16, further comprising the step of storing at least one of the first instructions, an identity of the first recording, and the second recording in memory.

17. The method of claim 16, further comprising the steps of receiving a notification regarding the first recording, the notification being based on the metadata.

18. The method of claim 16, wherein the first instructions comprise editing instructions to be applied to the first recording.

19. The method of claim 16, wherein the second instructions comprise further editing instructions to be applied to the second recording.

20. A system for editing a recording of an event, comprising:
a first server adapted to receive a first recording and first metadata associated with the first recording and to convert the first recording to a second recording; and
a second server adapted to receive the second recording and to provide editing instructions pertaining to at least one of the first recording and the second recording;
wherein at least one of the first recording and the second recording is edited according to the editing instructions, resulting in an edited recording.

21. The system of claim 21, further comprising a third server adapted to receive the edited recording for application of at least one of further editing instructions and addition of second metadata.

22. The system of claim 21, wherein the second server further comprises memory for storing at least one of a history of the editing instructions, the second recording, and the edited recording.
